(19) United States
(12) Patent Application Publication
(10) Pub. No.: US 2026/0297773 A1
(43) Pub. Date: Oct. 1, 2026

(54) SELF-STANDING BI-FUNCTIONAL ELECTRODE FOR OVERALL WATER ELECTROLYSIS

(71) Applicant: COUNCIL OF SCIENTIFIC & INDUSTRIAL RESEARCH, New Delhi (IN)

(72) Inventors: Geeta Pandurang KHARABE, Pune (IN); Rajith ILLATHVALAPPIL, Pune (IN); Sidharth BARIK, Pune (IN); Sreekumar KURANGOT, Pune (IN)

(21) Appl. No.: 19/164,463

(22) PCT Filed: Mar. 14, 2024
(86) PCT No.: PCT/IN2024/050263

§ 371 Date: Sep. 11, 2025

(30) Foreign Application Priority Data
Mar. 14, 2023 (IN) 202311017233

(51) Int. Cl. C25B 11/091; C23C 18/12; C25B 9/17; C25B 11/031; C25B 11/052; C25B 11/061

(52) U.S. Cl. CPC C25B 11/091; C23C 18/1204; C23C 18/1241; C23C 18/1283; C23C 18/1291; C25B 9/17; C25B 11/031; C25B 11/052; C25B 11/061

(57) ABSTRACT

The present invention relates to ternary metal(s) hydroxide [(M1-M2-Ni)](OH)₂] composite supported on nickel foam (NF) having nanoflower arrays structure, which acts as a self-standing bifunctional electrocatalyst for cathode as well as anode (both electrodes) for water electrolysis/splitting. Further, the present invention provides hydrothermal process for the preparation of said bi-functional electrocatalyst. The bifunctional catalyst disclosed herein is useful in performing water electrolysis reactions to generate hydrogen and oxygen.

### FILED OF THE INVENTION

The present invention relates to a self-standing bi-functional electrocatalyst comprising ternary metal(s) hydroxide [(M1-M2-Ni)](OH)₂ supported on support of nickel foam (NF), which is having a nanoflower array structure. More particularly, the present invention relates to ternary metal(s) hydroxide [(M1-M2-Ni)](OH)₂ supported on nickel foam (NF) and having nanoflower arrays structural feature to act as a self-standing bi-functional electrocatalyst for acting on cathode as well as the anode (both electrodes) for water electrolysis/splitting. Furthermore, the present invention relates to a process for the preparation of a self-standing bi-functional electrocatalyst and the use thereof as a self-standing bi-functional electrocatalyst in water electrolysis.

### BACKGROUND OF THE INVENTION

The exploration of renewable sources for sustainable energy production is receiving wide interest due to the global warming issues allied with fossil fuel-based energy sources. Replacing fossil fuels with sustainable energy sources is crucial to mitigate environmental problems. In this circumstance, Hydrogen (H₂) is presented as the upcoming energy source with zero carbon emission. Compared to the steam reforming of natural gas for conventional H₂ production, electrochemical water splitting is a zero-greenhouse gas emission process for clean H₂ production and, hence, the process becomes attractive. Challenges are associated with H₂ production through water electrolysis due to kinetic barriers on respective electrodes.

Electrocatalysts are essential to lower the activation energy barrier for the half-cell reactions and to further improve the overall system efficiency. Hydrogen evolution reaction (HER) is the cathodic reaction in water splitting and Pt/C is usually employed as the HER catalyst on the cathode. In fuel cell technology, specifically, the H₂—O₂ fuel cell is one of the methods of producing energy in a more environmentally friendly manner than the other existing ones in order to meet the clean and ever-increasing energy demand. Sustainability and eco-friendly nature of H₂—O₂ fuel cell totally depends on source of H₂, and water splitting can be best solution.

The global-scale application of water electrolysis, a technology to store intermittent renewable energy in the form of hydrogen fuel, is possible only by the development of inexpensive, robust, and bifunctional electrocatalysts. The electrocatalyst dependency on expensive noble metals well as their poor durability in the corrosive environment, such as RuO₂ and IrO₂, obstruct their large-scale application.

Hai Chao Chen et al., Energy Storage Materials, Volume 17, February 2019, Pages 194-203, reports an amorphous nickel-cobalt-manganese hydroxide (NiCoMn—OH) which was hydrothermally synthesized using a mixed solvent strategy and used as positive electrode materials for supercapacitor-battery hybrid energy storage system. Another report of KHANG Ngoc Dinh et al., Small, 2018 February; 14 (8), reports hydrothermal synthesis of porous ultrathin ternary NiFeV layer double hydroxides (LDHs) nanosheets grown on Nickel foam (NF) substrate as a highly efficient electrode toward overall water splitting in alkaline media.

Accordingly, for said reports and in the literature, for the generation of H₂ and an O₂, electrochemical reaction is done conventionally by water splitting which include HER (hydrogen evolution reaction—2H++2 e⁻→H₂, is the cathodic reaction), and OER (oxygen evolution reaction) reactions. Such reactions have many limitations like higher energy requirement, conventionally available catalysts are costly and not reliable, wettability is poor, exposure time, bubble entrapment at electrode active sites, etc.

Therefore, in order to address the shortcomings of the prior art, there is a dire need to provide an efficient and better self-standing bifunctional electrocatalyst which is capable of acting as a both cathode and anode) for water-spitting reactions.

### OBJECTIVES OF THE INVENTION

An objective of the present invention is to provide a self-standing bifunctional electrocatalyst for water electrolysis/splitting.

Another objective of the present invention is to provide a self-standing bi-functional electrocatalyst comprising ternary metal(s) hydroxide [(M1-M2-Ni)](OH)₂] supported on support of nickel foam (NF), for water electrolysis/splitting.

Another objective of the present invention is to provide a self-standing bi-functional electrocatalyst comprising ternary metal(s) hydroxide [(M1-M2-Ni)](OH)₂] supported on support of nickel foam (NF) with a nanoflower array structure, for water electrolysis/splitting.

Yet another objective of the present invention is to provide a process for the preparation of said self-standing bifunctional electrocatalyst for water electrolysis/splitting.

### SUMMARY OF THE INVENTION

Broadly, the present invention relates to hydroxides and (oxy) hydroxides of transition metals and combination thereof to formulate and arrive at a novel self-standing bifunctional electrocatalyst. The present invention relates to novel ternary metal(s) hydroxide [(M1-M2-Ni)](OH)₂ composite supported on nickel foam (NF) and having nanoflower arrays structural feature to act as a self-standing bifunctional electrocatalyst for cathode as well as anode (both electrodes) for water electrolysis/splitting.

In an aspect, the present invention provides a multi-metallic system comprising of transition metals, where at least one of the transition metals is present in multiple oxidation states, improving the bifunctional catalytic activity. Further, the presence of at least one transition metal in the tetravalent state provides structural stability and makes the system robust.

In an aspect, the present invention relates to a self-standing bifunctional electrocatalyst characterized by hydrophilic nature and can be employed as bi-functional and self-standing electrodes for water-splitting reaction; wherein the catalyst comprises ternary metal(s) hydroxide [(M1-M2-Ni)](OH)₂] composite supported on nickel foam (NF); and the catalyst is having nanoflower arrays structural.

In an aspect, the present invention provides a bifunctional electrocatalyst comprising ternary metals hydroxide composite having formula of (M1-M2-Ni)(OH)₂ supported onto support; wherein, the hydroxides of M1, M2 and nickel are uniformly present over the support; and wherein the bifunctional electrocatalyst composite is having a hierarchical nanoflower morphology.

In another embodiment, the support is selected from nickel foam, copper foam, Ti foil, Carbon Cloth (CC), etc.

In another aspect, the water splitting is performed by employing the self-standing bifunctional electrocatalyst onto the cathode and anode in the water electrolyzer.

In another aspect, the present invention provides binder-free synthesized electrodes having a high surface area with improved electrical conductivity, and the ability to facilitate better mass transport in the system along with better catalytic activities for the overall water splitting.

The electrocatalyst demonstrates catalytic activity for both the oxygen evolution reaction (OER) and the hydrogen evolution reaction (HER).

The amount of M1-hydroxide is in the range of 10-20% of total weight of the electrocatalyst, amount of M2-hydroxide is in the range of 20-30% of total weight of the electrocatalyst, and nickel hydroxide is in the range of 50-60% of total weight of the electrocatalyst.

The M1 metal is selected from Mn, Zn, Fe, Cu and Ni, and M2 metal is selected from Co, Zn, Fe, Cu and Ni.

When M1 is Mn and M2 is Co, then oxidation states of metals M1, M2 and Ni in said composite catalyst are: Ni as +2, Co as +2, and Mn as +2 & +3.

In another aspect, the present invention relates to one-pot hydrothermal synthesis process for the preparation of ternary metal(s) hydroxide, M1-M2-Ni(OH)₂ supported on nickel foam (NF) and having nanoflower arrays structural feature without the need of binder/additive to have hydrophilic electrode.

In another aspect, the present invention provides a one-pot hydrothermal process for preparation of bifunctional electrocatalyst, comprising the steps of:
i. cleaning nickel foam with HCl, deionized water, and ethanol consecutively by bath sonication for 10-15 min followed by drying in the vacuum oven at 50-60° C. for 5-6 h to obtain precleaned nickel foam;
ii. dispersing precursors of M1 metal salt and M2 metal salt in deionized water by stirring for 10-25 min at 20-25° C. to obtain solution;
iii. transferring the solution of step ii and precleaned nickel foam of step i into at eflon-lined autoclave placed in oven;
iv. performing hydrothermal treatment of step ill at 170-180° C. for 11-13 h in an oven containing said autoclave followed by cooling down to 25° C. to obtain material;
V. removing the teflon-lined autoclave from oven and then removing the material as obtained in step iv from the eflon lined autoclave followed by washing three times with an ethanol-DI water mixture (1:1); and
vi. drying the obtained material from step v in a vacuum oven for 5-6 h at 60-70° C. to obtain the bifunctional electrocatalyst.

The precursor of M1 metal is selected from manganese acetate, iron acetate, zinc acetate, copper sulfate, copper acetate, and nickel acetate.

The precursor of M2 metal is selected from cobalt nitrate, iron nitrate, zinc nitrate, copper nitrate, and nickel nitrate.

The present invention also relates to process of preparation of said ternary metal(s) hydroxide, wherein M1-M2-Ni composite is directly grown on the NF surface to form the ordered structure obviating the need of a binder.

In another aspect, said [(M1-M2-Ni)](OH)₂ catalyst is formed in one step by hydrothermally reacting with non-precious metal hydroxides system with Ni foam support without the use of a binder, forming ternary metal hydroxide mixture with co-ordinate metal bonds of M1-M2-Ni wherein Ni from Ni foam support is bonded with said two metal hydroxides.

In another aspect, the present invention provides a half-cell comprising working electrode, reference electrode, counter electrode within electrolyte solution, wherein said working electrode comprises the bifunctional electrocatalyst.

The reference electrode is made of mercury (Hg) and mercury (II) oxide (HgO).

The counter electrode is made of Graphite rod.

The electrolyte solution is selected from a basic solution of Potassium Hydroxide in the range of 1-4 M, and an acidic solution comprising Hydrochloric acid, Sulfuric acid or a combination thereof with concentration in the range of 1-4 M.

In another aspect, the present invention provides a full-cell comprising cathode, anode, and electrolyte solution; wherein said cathode and/or anode comprises said bifunctional electrocatalyst.

The electrolyte solution is potassium hydroxide or sodium hydroxide with concentration in the range of 1-4 M.

In specific aspect, the present invention discloses a bifunctional electrocatalyst characterized by a ternary metal hydroxide comprising (Co_{0.3}Mn_{0.1}Ni_{0.6})(OH)₂, composite wherein, the hydroxides of cobalt, manganese and nickel are uniformly present with amount of cobalt hydroxide as 30%, amount of manganese hydroxide as 10% and nickel hydroxide as 60%; wherein said ternary metal hydroxide is supported on nickel foam (NF); and wherein the (Co_{0.3}Mn_{0.1}Ni_{0.6})(OH)₂ composite is directly grown on the NF surface to form a hierarchical nanoflower morphology.

In another specific aspect, one-pot hydrothermal synthesis process for preparation of ternary metal(s) hydroxide, M1-M2-Ni(OH)₂ supported on nickel foam (NF) and having nanoflower arrays structural feature comprises the steps of:
i. cleaning Ni foam (NF) with 1M HCl solution, deionized water, and alcohol consecutively in a bath sonication for time period of 10-15 min followed by drying in the vacuum oven at 60-70° C. for 5-6 hrs;
ii. dispersing at least one salt of transition metals in deionized water by stirring for 15-30 min at 25° C. to obtain solution;
iii. transferring the solution of step ii and precleaned Ni foam (NF) into a Teflon-lined autoclave placed in oven, wherein the precleaned NF is kept vertically;
iv. performing hydrothermal treatment of step iii at 180° C. for 12 h in the oven containing said autoclave followed by cooling down to 25-30° C. to obtain material;
V. removing the Teflon-lined autoclave from oven, and then removing the material obtain in step iv from the Teflon-lined autoclave followed by washing the material three times with an ethanol-DI water mixture (1:1); and
vi. drying the material from step v in a vacuum oven for 5 h at 60° C. and the obtained material is named henceforth as ternary metal(s) hydroxide composite.

### DESCRIPTION OF DRAWINGS

FIG. 1. FE-SEM images of (Co0.3Mn0.1Ni0.6)(OH)2/NF: (a) the flower type morphology of (Co0.3Mn0.1Ni0.6)(OH)2/NF, (b) the magnified image of the portion marked in the square in (a), (c) the high magnified image of (Co0.3Mn0.1Ni0.6)(OH)2/NF, and (d, e, f, and g) represent the elemental mapping of (Co0.3Mn0.1Ni0.6)(OH)2/NF, showing the uniform dispersion of cobalt (Co), manganese (Mn), nickel (Ni), and oxygen (O), respectively.

FIG. 2. (a-b) TEM images of (Co_{0.3}Mn_{0.1}Ni_{0.6})(OH)₂/NF at different magnifications, (c) zoomed part marked in (b) with SAED pattern in the inset, (d) d-spacing measurements of the marked regions (represented as d1, d2 and d3), and (e) HAADF-STEM EDX elemental mapping of (Co0.3Mn0.1Ni0.6)(OH)₂/NF corresponding to Co (e1), Mn (e2), Ni (e3) and O (e4).

FIG. 3. Mn(OH)₂/NF, Ni(OH)₂/NF, and bare NF; and (b) XRD pattern of (Co_{0.3}Mn_{0.1}Ni_{0.6})(OH)₂/NF and Co(OH)₂/NF with the respective JCPDS files.

FIG. 4. Tomography images of (a) Bare NF and (b-d) (Co_{0.3}Mn_{0.1}Ni_{0.6})(OH)₂/NF; the contact angle measurement of (e) Bare NF, and (f) (Co_{0.3}Mn_{0.1}Ni_{0.6})(OH)₂/NF

FIG. 5. XPS spectra of (a) deconvoluted Co 2p of Co(OH)₂/NF, (b) deconvoluted Co 2p of (Co_{0.3}Mn_{0.1}Ni_{0.6})(OH)₂/NF, (c) deconvoluted Mn 2p of Mn(OH)₂/NF, (d) deconvoluted Mn 2p of (Co_{0.3}Mn_{0.1}Ni_{0.6})(OH)₂/NF, (e) deconvoluted Ni 2p of (Co_{0.3}Mn_{0.1}Ni_{0.6})(OH)₂/NF, and (f) deconvoluted O 1s of (Co_{0.3}Mn_{0.1}Ni_{0.6})(OH)₂/NF.

FIG. 6. (a) The OER polarisation plots of (Co_{0.3}Mn_{0.1}Ni_{0.6})(OH)₂/NF and the control samples performed in 1 M KOH electrolyte, (b) the OER overpotential bar diagram, (c) the electrochemical impedance data of the samples performed at 1.5 V in 1M KOH electrolyte, (d) the OER Tafel plot comparison of the prepared materials and (e) the OER chronoamperometric (CA) stability test performed in 1M KOH at 20 mA cm⁻².

FIG. 7. (a) The HER polarisation plots of (Co_{0.3}Mn_{0.1}Ni_{0.6})(OH)₂/NF and the control samples performed in 1 M KOH electrolyte, (b) the HER overpotential bar diagram, (c) the electrochemical impedance analysis of the samples performed at −0.30 V in 1M KOH electrolyte, (d) the HER Tafel plots comparison of the prepared materials and (e) the HER chronoamperometric stability test performed in 1M KOH at 20 mA cm⁻².

FIG. 8. (a) Schematic representation of the water electrolyzer, (b and c) comparative LSV plots corresponding to the overall water splitting, (d) the bar diagram representing the water electrolysis activity of (Co_{0.3}Mn_{0.1}Ni_{0.6})(OH)₂/NF compared with the Bare NF and the state-of-the-art catalyst at different current densities, and (e) the chronoamperometric response of the (Co_{0.3}Mn_{0.1}Ni_{0.6})(OH)₂/NF-based electrolysis in 1M KOH for 24 h at 20 mA cm⁻²

FIG. 9. The FE-SEM images recorded at different magnifications of (a-b) Bare NF, (c-d) Ni(OH)₂/NF, (e-f) Co(OH)₂/NF, and (g-h) Mn(OH)₂/NF.

FIG. 10. (a) FESEM and (b) Colour-coded thickness profile obtained from tomography images of (Co_{0.3}Mn_{0.1}Ni_{0.6})(OH)₂/NF

FIG. 11. (a) Comparative XRD patterns of (Co_{0.3}Mn_{0.1}Ni_{0.6})(OH)₂/NF, Co(OH)₂/NF, and Ni(OH)₂/NF, (b) comparative XRD profiles of (Co_{0.3}Mn_{0.1}Ni_{0.6})(OH)₂/NF, CoMn/NF-(1:1) and CoMn/NF-(2:1), and (c) Raman spectrum of (Co_{0.3}Mn_{0.1}Ni_{0.6})(OH)₂/NF (d) XPS survey spectrum of (Co_{0.3}Mn_{0.1}Ni_{0.6})(OH)₂/NF and (e) Co 2p

FIG. 12. (a) Half-Cell and (b) Full-cell

FIG. 13. FE-SEM images: (a) the relatively rough surface of (CoMn)/NF-(1:1), (b) the magnified image of the portion marked in the square in (a), (c) the sheet-like morphology with randomly oriented structure, (d) the rough surface morphology of (CoMn)/NF-(2:1), (e) the magnified image of the portion marked in the square in (d) and (f) the high-magnified image of (CoMn)/NF-(2:1) with the stacked-type morphology.

FIG. 14: (a) HR-TEM-EDX of (Co_{0.3}Mn_{0.1}Ni_{0.6})(OH)₂/NF and (b) SEM-EDX of (Co_{0.3}Mn_{0.1}Ni_{0.6})(OH)₂/NF.

FIG. 15. (a-c) TEM images of Co(OH)₂/NF recorded at different magnifications and (d) the corresponding SAED pattern.

FIG. 16. (a-c) TEM images of Mn(OH)₂/NF recorded at different magnifications and (d) inset shows SAED pattern of Mn(OH)₂/NF indicates the crystalline nature.

FIG. 17. The contact angle measurement of (a) Co(OH)₂/NF, (b) Mn(OH)₂/NF, and (c) Ni(OH)₂/NF.

FIG. 18: The comparative LSVs of (CoMn)/NF-(1:1) and (CoMn)/NF-(2:1), recorded in 1M KOH.

FIG. 19. The plots of the cathodic current density against the scan rate in the non-Faradaic region of 0.915 to 1.015 V vs. RHE.

FIG. 20. The plots of the cathodic current density against the scan rate in the non-Faradaic region of 0.915 to 0.815 V vs. RHE.

FIG. 21, represents table of contain (TOC), the alkaline water electrolysis for the green H₂ production using nanoflower arrays of ternary metal hydroxides ((Co_{0.3}Mn_{0.1}Ni_{0.6})(OH)₂/NF) as the self-standing bi-functional catalyst.

### DETAILED DESCRIPTION OF THE INVENTION

The present invention relates to novel ternary metal(s) hydroxide [(M1-M2-Ni)](OH)₂ composite supported on nickel foam (NF) and having nanoflower arrays structural feature to act as a self-standing bifunctional electrocatalyst for cathode as well as anode (both electrodes) for water electrolysis/splitting.

The term bifunctional electrocatalysts as disclosed in the present invention means that the electrocatalysts can be used for both electrodes i.e., for cathode and anode; and for OER and HER reactions.

The term bi-functional electrode, binder-free synthesized electrodes, and self-standing bifunctional electrocatalyst are used interchangeably throughout the specification and these terms bear the same meaning throughout the specification.

The term ternary metal(s) hydroxide or ternary metal(s) hydroxide [(M1-M2-Ni)](OH)₂] or ternary metal(s) hydroxide [(M1-M2-Ni)](OH)₂ composite, and multi-metallic system or mixed metal system are used interchangeably throughout the specification and these terms bear the same meaning throughout the specification.

The term “OER” refers to oxygen evolution reaction (OER), which is a limiting reaction in the process of generating molecular oxygen through chemical reaction, such as the oxidation of water during oxygenic photosynthesis, electrolysis of water into oxygen and hydrogen, and electrocatalytic oxygen evolution from oxides and oxoacids. The oxygen evolution reaction (OER, 2H2O→O₂+4H++4e−) is the complementary anodic half reaction in electrochemical water splitting. Requiring four proton and electron transfers per oxygen molecule, the OER is the more complex of the two half reactions and is consequently responsible for the majority of inefficiency in electrolyzer devices. The term “HER” refers to hydrogen evolution reaction (HER, 2H++2 e⁻→H₂) is the cathodic reaction in electrochemical water splitting. The HER is a classic example of a two-electron transfer reaction with one catalytic intermediate, and offers the potential to produce H₂, a critical chemical reagent and fuel. (refer, https://jaramillogroup.stanford.edu/catalysis.html)

In general embodiment, the present invention provides a multi-metallic system comprising of transition metal, where at least one of the transition metals is present in multiple oxidation states, improves the bifunctional catalytic activity. Further, the presence of at least one transition metal in the tetravalent state provides structural stability and makes the system robust.

In another general embodiment of the present invention, hydroxides and (oxy) hydroxides of transition metals and combination thereof are used to formulate novel self-standing bifunctional electrocatalysts.

In an embodiment, the present invention relates to a self-standing bifunctional electrocatalyst comprising hydrophilic nature and is capable to be employed as bi-functional and self-standing electrodes for water-splitting reaction; wherein the catalyst comprises ternary metal(s) hydroxide [(M1-M2-Ni)](OH)₂] composite supported on nickel foam (NF); the catalyst is having nanoflower arrays structural; and wherein the transition metals are selected from Co, Mn, Fe, Zn, Zr, Ru, and Ni.

In another embodiment, the present invention relates to a self-standing bifunctional electrocatalyst which is characterized by hydrophilic nature and is employed as bi-functional and self-standing electrodes for water splitting/electrolysis.

In an embodiment, metallic foams such as Ni-foam, Cu-foam, and Ti foil are used a substrate for the synthesis of ternary metal hydroxide [(M1-M2-Ni)](OH)₂ composite.

In a preferred embodiment, nickel foam is used as a substrate for the synthesis of ternary metal(s) hydroxide [(M1-M2-Ni)](OH)₂ composite.

In another embodiment, the water splitting is performed by employing the self-standing bifunctional electrocatalyst both as the cathode and anode in the water electrolyser.

In another embodiment, present invention provides binder-free synthesized electrodes having a high surface area with improved electrical conductivity, and the ability to facilitate better mass transport in the system along with better catalytic activities for overall water splitting.

In another embodiment, the multi-metallic system comprising of oxides/hydroxides of Co, Mn, and Ni metals, wherein the Mn is present in multiple oxidation states, improving the bifunctional catalytic activity. The Mn in the tetravalent state provides structural stability and makes the system robust.

In another embodiment of the present invention, the combination of both cobalt and manganese metals in the hydrothermal treatment, changes the morphology of the obtained material from nanoparticle to flower-like structure, wherein the flower-like morphology possesses the advantages of significantly increasing the electrochemical active surface area and provide easy diffusion of the electrolyte and the evolved gasses during the water electrolysis.

In another embodiment of the present invention, the as-synthesized self-supported electrodes exhibited remarkable performance in terms of over potential of 270 mV for OER and 165 mV for HER at a current density of 10 mA cm⁻² and excellent long-term stability.

In another embodiment, the present invention relates to ternary metal hydroxide, (Co_{0.3}Mn_{0.1}Ni_{0.6})(OH)₂, supported on nickel foam (NF), wherein, the hydroxides of cobalt, manganese and nickel are uniformly present with amount of cobalt hydroxide as 30%, amount of manganese hydroxide as 10% and nickel as 60%, represented as (Co_{0.3}Mn_{0.1}Ni_{0.6})(OH)₂/NF.

In preferred embodiment, when the M1 is Mn and M2 is Co in said ternary bifunctional electrocatalyst of [(M1-M2-Ni)](OH)₂ composite, then the oxidation states of metals in said catalyst are: Ni as +2, Co as +2, and Mn as +2 & +3.

In a preferred embodiment, the present invention relates to ternary metal hydroxide, (Co_{0.3}Mn_{0.1}Ni_{0.6})(OH)₂, supported on nickel foam (NF) and having a hierarchical nanoflower morphology. Moreover, the (Co_{0.3}Mn_{0.1}Ni_{0.6})(OH)₂ composite is directly grown on the NF surface to form the ordered structure.

In another embodiment, the binder-free synthesized electrodes have a high surface area with improved electrical conductivity, and the ability to facilitate better mass transport in the system. The obtained (Co_{0.3}Mn_{0.1}Ni_{0.6})(OH)₂/NF system exhibited better catalytic activities for the overall water splitting.

In another embodiment, the present invention relates to one-pot hydrothermal synthesis process for the preparation of ternary metal(s) hydroxide, M1-M2-Ni supported on nickel foam (NF) and having nanoflower arrays structural feature without the need of binder/additive to have a hydrophilic electrode. The invention also relates to process of preparation of said ternary metal(s) hydroxide, M1-M2-Ni composite which is directly grown on the NF surface to form the ordered structure obviating need of binder.

In another embodiment, the said [(M1-M2-Ni)](OH)₂ catalyst is formed in one step by hydrothermal process by reacting non-precious metal hydroxides with Ni foam support without using any binder, forming a ternary metal hydroxide mixture with co-ordinate metal bonds of M1-M2-Ni wherein Ni from Ni foam support is bonded with said two metal hydroxides and wherein, nonprecious metals are selected from Co, Mn, Zn, Fe, Cu and Ni and Mn is present in multiple oxidation states, improves the bifunctional catalytic activity. The Mn in the tetravalent state provides structural stability and makes the system robust.

In another embodiment, the present invention further comprising of half-cell and full-cell comprising cathode, anode, and the said ternary metal(s) hydroxide [(M1-M2-Ni)](OH)₂ supported on nickel foam (NF).

In another embodiment, in the half-cell reaction, said catalyst imparts better charge transfer property due to nanoflower array structure causing lower loop in impedance data points. Also, it has better wettability and stability more than 24 hrs for generation of H₂ and O₂. The same advantages apply for full-cell reactions including that it has combined effects of HER and OER reactions with single catalyst rather than using two different metal catalysts e.g. commercial Pt—Ru catalyst. Additionally, full-cell testing done indicated good overpotential than commercial Pt—Ru electrodes, thereby show better water splitting and H₂ generation up to 100 mA current density.

In an embodiment, the present invention discloses a bifunctional electrocatalyst characterized by a ternary metal hydroxide comprising (Co_{0.3}Mn_{0.1}Ni_{0.6})(OH)₂, composite wherein, the hydroxides of cobalt, manganese and nickel are uniformly present with amount of cobalt hydroxide as 30%, amount of manganese hydroxide as 10% and nickel hydroxide as 60%; wherein said ternary metal hydroxide is supported on nickel foam (NF); and wherein the (Co_{0.3}Mn_{0.1}Ni_{0.6})(OH)₂ composite is directly grown on the NF surface to form a hierarchical nanoflower morphology.

In another embodiment, said electrocatalyst has catalytic activity for both the oxygen evolution reaction (OER) and the hydrogen evolution reaction (HER).

In yet another embodiment, when the M1 is Mn and M2 is Co, in said ternary bifunctional electrocatalyst of [(M1-M2-Ni)](OH)₂ composite, the oxidation states of metals in said catalyst are: Ni as +2, Co as +2, and Mn as +2 & +3.

In still another embodiment, said nonprecious metals are selected from Co, Mn, Zn, Fe, Cu and Ni and Mn and are present in multiple oxidation states.

In another embodiment, one-pot hydrothermal synthesis process for the preparation of ternary metal(s) hydroxide, M1-M2-Ni(OH)₂ supported on nickel foam (NF) and having nanoflower arrays structural feature comprises the steps of:
i. cleaning NF with a specific dimension with 1M HCl, deionized water, and ethanol consecutively by bath sonication for 10-15 min followed by drying in the vacuum oven at 60° C. for 5-6 h;
ii. dispersing at least one hydroxide and (oxy) hydroxide of transition metals in deionized water (30 mL) by stirring for 15 min at 25° C.;
iii. transferring the obtained solution of step ii and precleaned NF into a Teflon-lined autoclave placed in oven, wherein the precleaned NF is kept vertically;
iv. performing hydrothermal treatment of step iii at 180° C. for 12 h in an oven containing said autoclave as a container followed by cooling down to 25° C. to obtain material;
V. removing the Teflon-lined autoclave from oven and then removing the material obtained in step iv from the Teflon-lined autoclave followed by washing three times with an ethanol-DI water mixture (1:1); and
vi. drying the obtained material from step v in a vacuum oven for 5-6 h at 60-70° C. and the obtained material is named henceforth as ternary metal(s) hydroxide composite.

In another embodiment, the Teflon line autoclave may have capacity in the range of 40 ml to 1500 ml or more up to 10 L as per the requirement. Specifically, the capacity of autoclave is in range of 40 ml to 1500 ml.

In another embodiment, the present invention discloses a half-cell comprising working electrode, reference electrode, counter electrode within the electrolyte solution and a ternary metal(s) hydroxide [(M1-M2-Ni)](OH)₂ supported on nickel foam (NF) electrocatalyst as a working electrode.

In yet another embodiment, said reference electrode is made up of half-cell composed of mercury (Hg) and mercury (II) oxide (HgO) and the counter electrode is made up of Graphite rod.

In still another embodiment, said electrolyte solution is selected from Potassium Hydroxide in the range of 1-4 M.

In another embodiment, said acidic medium is selected from hydrochloric acid, Sulfuric acid and a combination thereof.

In yet another embodiment, said ternary metal(s) hydroxide [(M1-M2-Ni)](OH)₂ supported on nickel foam (NF) electrocatalyst as a working electrode.

In another embodiment, the present invention provides a full-cell comprising cathode, anode, electrolyte solution KOH) and a ternary metal(s) supported on nickel foam (NF) electrocatalyst as a cathode and anode.

In yet another embodiment, said electrolyte solution is selected from an aqueous solution of an acid, base, or salt, and preferably Potassium Hydroxide.

In still another embodiment, said ternary metal(s) hydroxide [(M1-M2-Ni)](OH)₂ supported on nickel foam (NF) electrocatalyst as a cathode and anode.

In a preferred embodiment, the present invention relates to ternary metal hydroxide, (Co_{0.3}Mn_{0.1}Ni_{0.6})(OH)₂, supported on nickel foam (NF) through the hydrothermal process to obtained the hierarchical nanoflower morphology. Moreover, the (Co_{0.3}Mn_{0.1}Ni_{0.6})(OH)₂ composite is directly grown on the NF surface to form the ordered structure, which could avoid the use of a binder.

In an embodiment, the water splitting is performed in 1M KOH electrolyte with (Co_{0.3}Mn_{0.1}Ni_{0.6})(OH)₂/NF as the bi-functional catalyst both at the cathode and anode, which displayed prominent activity with excellent long-term stability.

In further embodiment of the present invention overall water splitting was performed in 1M KOH electrolyte and the corresponding data is presented in FIG. 8. The schematic representation of the water electrolyser is given in FIG. 8a.

In an embodiment, to investigate the water electrolysis, ((Co_{0.3}Mn_{0.1}Ni_{0.6})(OH)₂/NF was employed as both the anode and cathode electrodes in 1M KOH solution by maintaining an active area of 1 cm⁻².

In an embodiment, the (Co_{0.3}Mn_{0.1}Ni_{0.6})(OH)₂/NF system possesses remarkably high activity toward both OER and HER in a 1 M KOH solution. The overpotentials displayed by this system at 10 mA cm⁻² are 268 to 272 mV (or 270±2 Mv) for OER, and 163 to 167 mV (or 165±2 Mv) for HER. The structural stability analysis of (Co_{0.3}Mn_{0.1}Ni_{0.6})(OH)₂/NF during OER and HER shows outstanding durability and structural integrity of the system.

In an embodiment, the system required only 1.62 V to achieve the current density of 10 mA cm-2 with excellent long-term stability (24 h).

### EXAMPLES

### Example 1: Synthesis of (Co_{0.3}Mn_{0.1}Ni_{0.6})(OH)₂/NF

For the synthesis of (Co_{0.3}Mn_{0.1}Ni_{0.6})(OH)₂/NF, firstly, NF with a dimension of 3.5 cm×2.5 cm was cleaned with 1 M HCl, deionized water, and ethanol consecutively by bath sonication for 10-12 min. followed by drying in the vacuum oven at 60° C. for 5-6 h. For the synthesis of (Co_{0.3}Mn_{0.1}Ni_{0.6})(OH)₂/NF, NF was used as a substrate, and manganese acetate tetrahydrate (Mn (CH₃CO₂)₂·4H₂O, 1 mmol) and cobalt nitrate hexahydrate (Co(NO₃)₂·6H₂O, 0.5 mmol) were dispersed in deionized water (30 Ml) by stirring for 10-15 min. at room temperature. The obtained solution was transferred into a Teflon-lined autoclave of capacity 40 Ml and the precleaned NF was kept vertically in the container. Further, hydrothermal treatment was carried out at 180° C. for 12 h in an oven. After cooling down to room temperature, the material was removed from the Teflon-lined autoclave and washed three times with an ethanol-DI water mixture (1:1). The obtained material was dried in a vacuum oven for 5 h at 60° C. and the obtained material is named henceforth as (Co_{0.3}Mn_{0.1}Ni_{0.6})(OH)₂/NF. For comparison, Mn(OH)₂/NF and Co(OH)₂/NF were also synthesized under similar conditions except that only Mn(CH₃CO₂)₂·4H₂O and Co(NO₃)₂·6H₂O, respectively, were added to the autoclave instead of the mixture of Mn(CH₃CO₂)₂·4H₂O and Co(NO₃)₂·6H₂O. The mass loading of the active material on NF was deduced by considering the weight gain after the reaction, which was found to be nearly 3 mg cm⁻².

### Example 2: Physical Characterization

The morphological and compositional information was studied by field emission scanning electron microscopy (FESEM; Nova Nano SEM 450). A Tecnai T-20 instrument at an accelerating voltage of 200 Ky was used for transmission electron microscopy (TEM) imaging. High-resolution imaging and HAADF-STEM mapping were performed using the JEOL JEM F-200 HRTEM instrument. The samples for TEM and HRTEM were prepared by drop-wise coating the well-dispersed sample in isopropyl alcohol (a small piece of the sample dispersed in 1 Ml solvent) on a carbon-coated 200 mesh copper grid. The sample-coated TEM grid was dried for 1 h under an IR lamp. The crystallinity and phase purity of the synthesized samples were investigated through X-ray diffraction (XRD) analysis on a Rigaku SmartLab X-ray diffractometer with Cu Kα radiation (λ=1.5406 Å), at scan rate of 10°/min in 2θ range of 10 to 80°. The X-ray photoelectron spectroscopy (XPS) was performed on a Thermo Scientific Kα+, a fully integrated, monochromatic small-spot X-ray Photoelectron Spectroscopy (XPS) system.

The solid-liquid contact interface between the catalysts and water was characterized by an optical contact angle system (KRUS drop shape analyzer). Xradia Versa 510 X-ray microscope (Zeiss X-ray Microscopy, Pleasanton, CA, USA) was used to record micro-computed X-ray tomography (micro-CT) images in order to get 3D morphology.

### Example 3: Electrochemical Analysis

Electrochemical experiments were performed using a Bio-Logic potentiostat (VMP-3) in 1 M KOH electrolyte at room temperature. The activity and durability of the catalysts were measured by cyclic voltammetry (CV), linear sweep voltammetry (LSVs), and chronoamperometric methods using the three-electrode set-up. For this, the synthesized (Co_{0.3}Mn_{0.1}Ni_{0.6})(OH)₂/NF was employed as the working electrode with an active area of 1 cm², Hg/HgO as the reference electrode, and graphite rod as the counter electrode. To evaluate the HER performance of the samples, LSVs were measured from 0.20 to −0.60 V vs. RHE with a scan rate of 2 mVs⁻¹. To estimate the OER activity of the samples, LSVs were performed from 1.1 to 1.7 V vs. RHE at a scan rate of 2 mVs⁻¹. Chronoamperometric performance was evaluated at a current density of 20 mAcm⁻² for 24 h. All the potentials mentioned in the work are based on the RHE scale by calibrating the Hg/HgO in the H₂-saturated 1 M KOH solution.

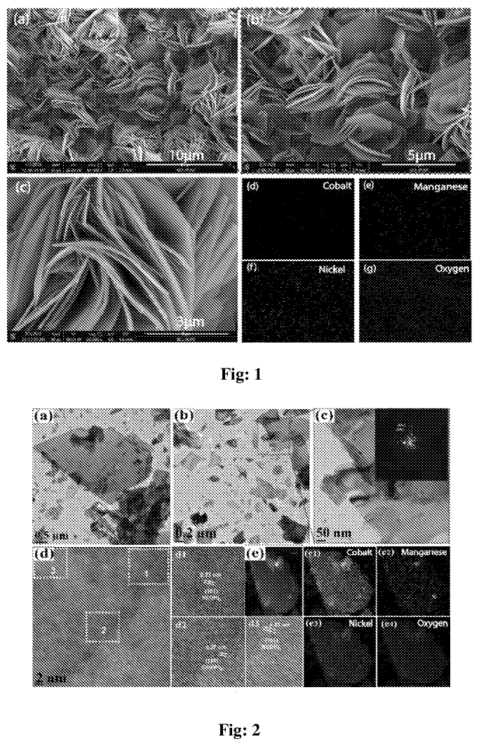

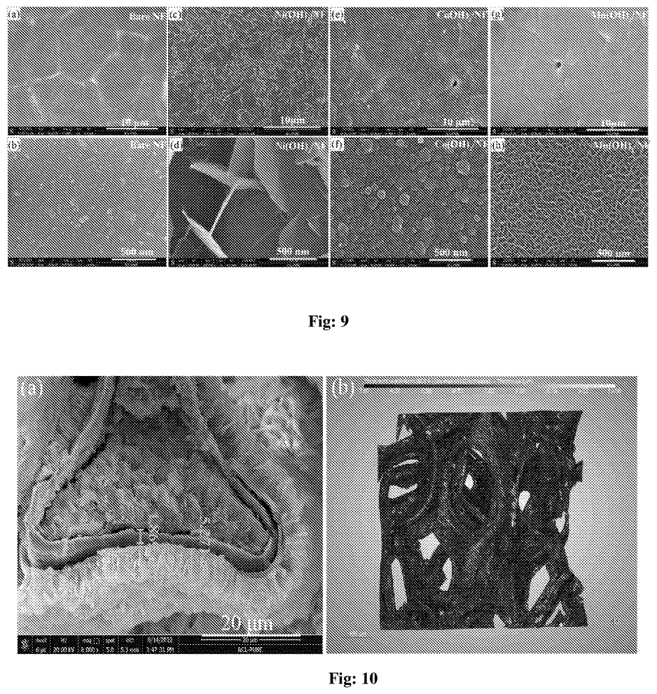

To check the morphological features of the obtained material, FESEM analysis was performed and the data is presented in FIG. 1. With the combination of both cobalt and manganese ions in the hydrothermal treatment, the morphology of the obtained material is changed from nanoparticle to flower-like. As illustrated in FIGS. 1a and b, the FESEM images of (Co_{0.3}Mn_{0.1}Ni_{0.6})(OH)₂/NF indicated the presence of flower-like hydroxide growth patterns over the NF surface. The flower-like morphology possesses the advantage of significantly increasing the electrochemical active surface area and would provide easy diffusion of the electrolyte and the evolved gasses during water electrolysis. The high-magnification FESEM image presented in FIG. 1c displays the vertical array of the (Co_{0.3}Mn_{0.1}Ni_{0.6})(OH)₂ sheets on NF. EDX-elemental mapping was performed to confirm the presence of the elements in (Co_{0.3}Mn_{0.1}Ni_{0.6})(OH)₂/NF. FIG. 1d-g confirmed that cobalt, manganese, nickel, and oxygen are uniformly present in (Co_{0.3}Mn_{0.1}Ni_{0.6})(OH)₂/NF. The SEM images in FIG. 9a-b show the bare NF surface. FIG. 9c-d illustrates the nickel hydroxide on NF (Ni(OH)₂/NF) and FIG. 9e-f corresponds to the cobalt hydroxide on NF (Co(OH)₂/NF) and manganese hydroxide on NF (Mn(OH)₂)/NF) (FIG. 9g-h) obtained through the hydrothermal treatment. The morphology of Co(OH)₂ exhibits dense particles on NF and Mn(OH)₂ exhibits an interconnected porous nanosheet type structure. In FIG. 10a cross section FE-SEM shows the obtained loading of (Co_{0.3}Mn_{0.1}Ni_{0.6})(OH)₂ over NF is 5.271 μm thick, which is comparable to the average thickness determined from the 3D tomography image (FIG. 10b). For the microstructural analysis, Transmission Electron Microscopy (TEM) imaging, high-resolution imaging, and HAADF-STEM mapping were performed. The TEM images in FIG. 2a-c reveal that the hydrothermal treatment with the mixture of Co and Mn ions results in a thin sheet of (Co_{0.3}Mn_{0.1}Ni_{0.6})(OH)₂/NF. The plane in the selected area electron diffraction (SAED) pattern of (Co_{0.3}Mn_{0.1}Ni_{0.6})(OH)₂/NF presented in the inset of FIG. 2c is readily indexed to the interplanar spacing of the hexagonal phase of the Co(OH)₂ structure. The d-spacing values of 0.46 and 0.28 nm are consistent with the (001) and As shown in FIG. 2d, the highlighted portions marked as d1 and d3 indicate the interplanar distance of 0.23 nm corresponding to the (101) plane of the Ni(OH)₂ and d2 with 0.27 nm corresponds to the (100) plane of the hexagonal Co(OH)₂. The HAADF-STEM image and the corresponding EDX mapping in FIG. 2e reveals the uniform distribution of Co (e1), Mn (e2), Ni (e3), and O (e4) in (Co_{0.3}Mn_{0.1}Ni_{0.6})(OH)₂/NF.

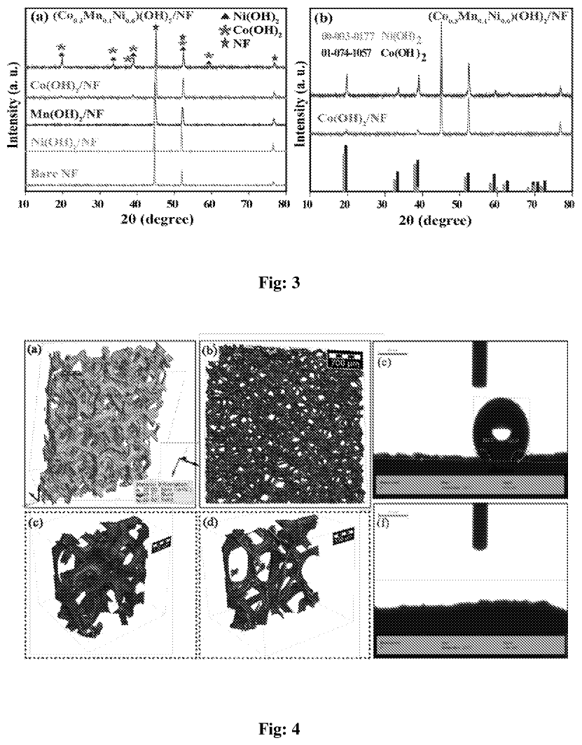

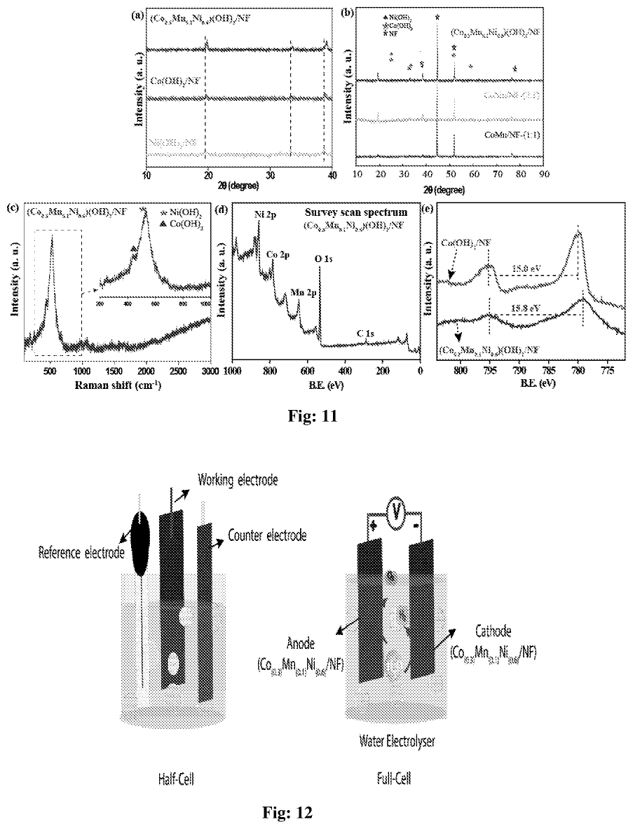

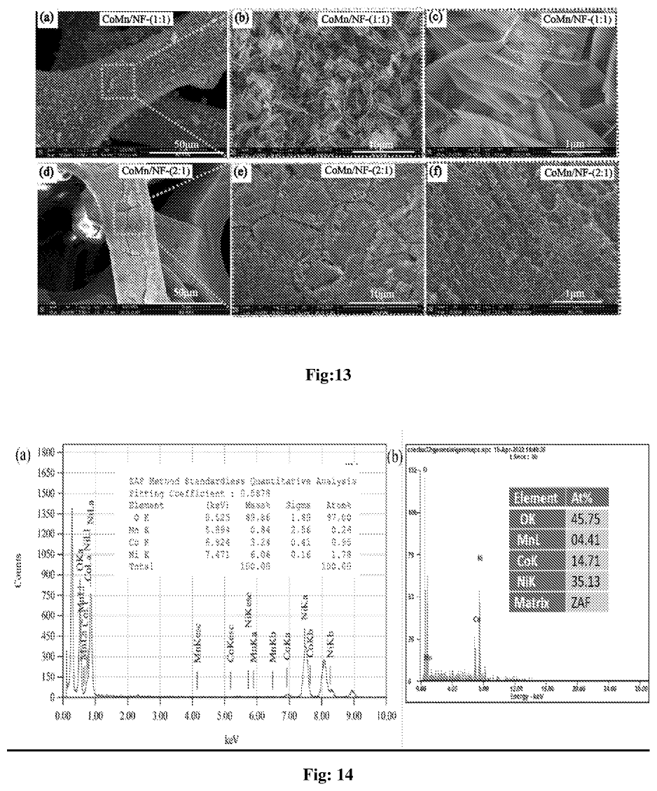

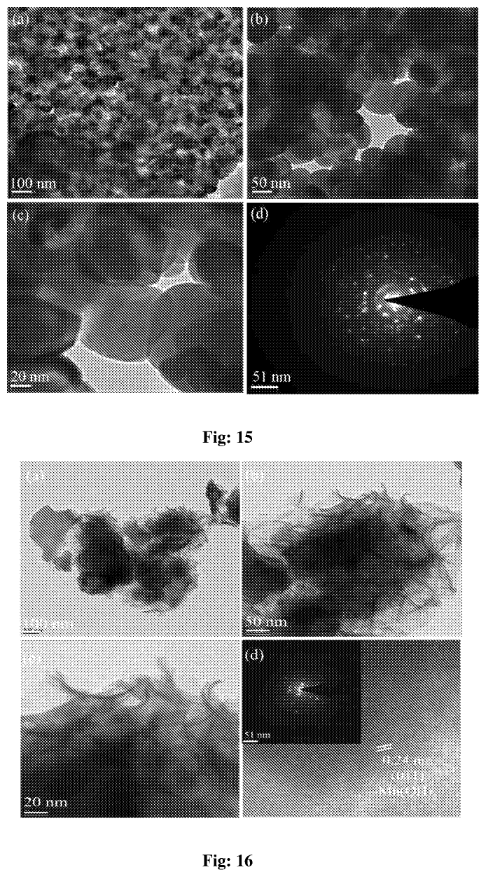

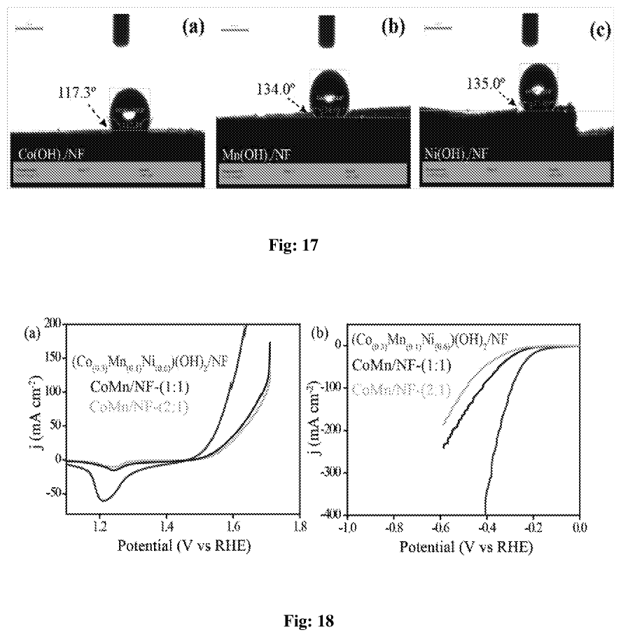

FIG. 3a shows the X-ray diffraction patterns of the as-synthesized materials. As observed in all the XRD patterns, the well-defined peaks located at 44.3°, 51.7°, and 76.6° correspond to the (111), (200), and (220) lattice planes of the metallic nickel, respectively, which are originated from the NF substrate (JCPDS No. 04-0850). The hydroxides of cobalt and nickel are displaying similar phase structures and are difficult to differentiate from each other. The prominent peaks located at 19.8°, 32.9°, 38.9°, 52.1°, and 59.5° are corresponding to the (001), (100), (002), (012), and (110) diffraction planes of the hexagonal phase of Ni(OH)₂ (JCPDS CARD No. 00-003-0177) and Co(OH)₂ (JCPDS CARD No. 01-074-1057), confirming the successful formation of (Co_{0.3}Mn_{0.1}Ni_{0.6})(OH)₂ over NF, in FIG. 3b. With the addition of the Mn ions in the hydrothermal process, the relative intensities of the peaks have increased in (Co_{0.3}Mn_{0.1}Ni_{0.6})(OH)₂/NF while maintaining the same crystal structure. From the literature reports, the ternary hydroxides (M (OH)₂, M=Co, Ni, Mn) acquire a similar structure for different metals. Co and Mn ions replace the Ni and the XRD peaks are slightly shifted to the higher 20 value as well as crystallinity of the material increases with increasing the peak intensity. Raman analysis was done to characterize the structure of (Co_{0.3}Mn_{0.1}Ni_{0.6})(OH)₂/NF and the spectrum is presented in FIG. 11c). The peaks at 438 cm⁻¹ and 531 cm⁻¹ correspond to the Co(OH)₂ and Ni(OH)₂ in (Co_{0.3}Mn_{0.1}Ni_{0.6})(OH)₂/NF, respectively. lattice planes of the hexagonal Co(OH)₂, respectively.

The 3D morphology of the Bare NF and (Co_{0.3}Mn_{0.1}Ni_{0.6})(OH)₂/NF was estimated by using non-invasive 3D X-ray microtomography. FIG. 4a shows the tomography image of Bare NF. The plane surface and porous arrangement evident from the tomography image are matching with FESEM images of the Bare NF. The (Co_{0.3}Mn_{0.1}Ni_{0.6})(OH)₂/NF tomography image is revealed in FIG. 4b-d. The green color in the core of the structure in FIGS. 4c and d indicates the Ni metal from the NF substrate and the red color shows the in-situ covered (Co_{0.3}Mn_{0.1}Ni_{0.6})(OH)₂. The uniformly distributed nanoflowers of (Co_{0.3}Mn_{0.1}Ni_{0.6})(OH)₂ are being confirmed by the tomography as it is seen as a layer on the NF. The porous macrostructure arrangement of the NF has been intact after the formation of the (Co_{0.3}Mn_{0.1}Ni_{0.6})(OH)₂ nanoflowers. Next to the morphological study, to understand the surface wettability and the nature of the electrode/electrolyte interface, the contact angle analysis was performed. During water electrolysis, H₂ and O₂ gas bubbles produce continuously over the catalyst surface and hinder the active sites, which results in decreased mass transport and electron transfer. The hydrophilic nature of the catalyst surface iFs required to make a better electrode/electrolyte interface and to further minimize the mass-transport-related issues. FIG. 4e shows that the water droplets remained over Bare NF, which indicates the highly hydrophobic nature of the Bare NF with a contact angle of 137.1° The formation of the hydroxide layer improves the contact between the electrode and electrolyte, leading to improved surface wettability, as depicted in FIG. 4f for (Co_{0.3}Mn_{0.1}Ni_{0.6})(OH)₃/NF.

FIG. 4e and FIGS. 18 (a to c) show that the water droplets remained over bare NF, Co(OH)2/NF, Mn(OH)2/NF, and Ni(OH)2/NF, which indicates the highly hydrophobic nature of the surface with a contact angle of 137.1°, 117.3°, 134.0°, and 135.0°, respectively. The flower-like morphology in (Co0.3Mn0.1Ni0.6)(OH)2/NF would increase the roughness factor of the surface and improve the surface wettability of the electrode. This resulted in the fast-spreading of the water droplet in (Co0.3Mn0.1Ni0.6)(OH)2/NF during the contact angle measurement, as depicted in FIG. 4f.

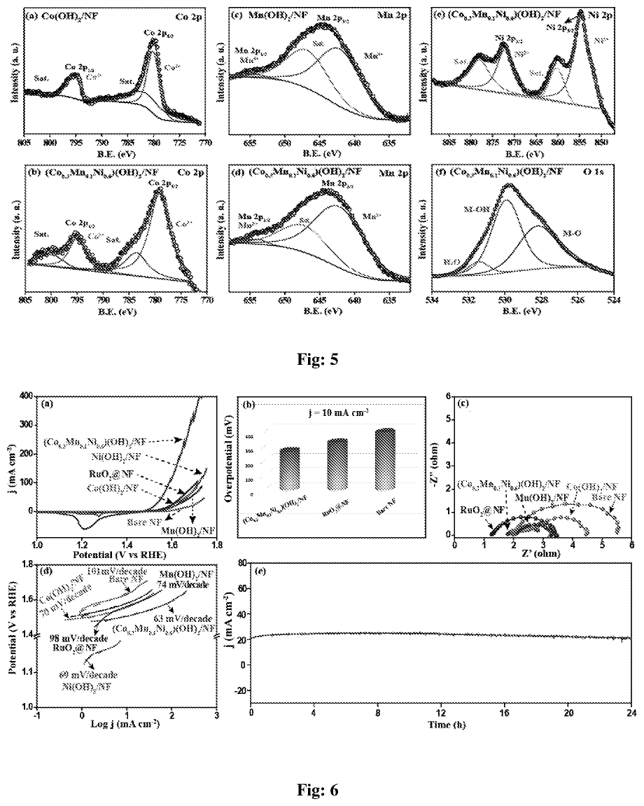

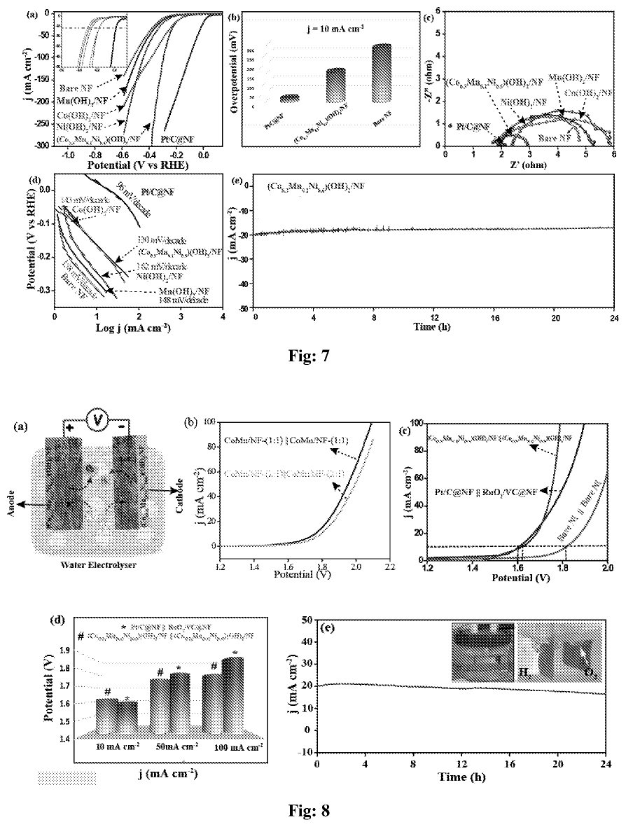

To know the chemical composition of (Co0.3Mn0.1Ni0.6)(OH)2/NF, XPS analysis was performed. FIG. 11d shows the survey scan spectrum of (Co0.3Mn0.1Ni0.6)(OH)2/NF and confirms the presence of Mn, Co, Ni, and O in the sample. The Co 2p spectrum displays peaks at 780.1 and 795.1 eV due to the spin-orbit effect, which is characteristic of Co 2p3/2 and Co 2p1/2 in Co(OH)2, respectively, and is shown in FIG. 5a. The Co 2p spectrum is deconvoluted into Co2+ at 780.0 and 795.5 eV along with two satellite peaks at 783.1 eV and 803.1 eV, respectively, for Co(OH)2. The Co 2p spectrum of (Co0.3Mn0.1Ni0.6)(OH)2/NF (FIG. 5d) shows peaks at 779.2 and 795.0 eV corresponding to the Co 2p3/2 and Co 2p1/2 peaks, respectively. The core level of Co is deconvoluted into 779.1 and 795.0 eV peaks of Co2+. Along with this, two satellite peaks could be seen appearing at 783.6 and 800.8 eV. In Co(OH)2/NF, the difference between Co 2p3/2 and Co 2p1/2 peaks is 15.0 eV (del E=15.0 eV). However, Co 2p3/2 and Co 2p1/2 in (Co0.3Mn0.1Ni0.6)(OH)2/NF exhibit a comparatively larger spin-orbit splitting value (DE) of 15.8 eV with peak shift towards lower binding energy (Fig. S10b†). The apparent negative shift of Co 2p3/2 and Co 2p1/2 in (Co0.3Mn0.1Ni0.6)(OH)2/NF compared to Co(OH)2 indicates an increased electronic density in (Co0.3Mn0.1Ni0.6)(OH)2/NF aer the incorporation of Mn. This is due to the difference in the electronegativity between Mn (1.55) and Co (1.88), and there could be a charge transfer from Mn to Co in (Co0.3Mn0.1Ni0.6)(OH)2/NF.44 It is also confirmed through the deconvoluted Mn core level spectrum of Mn(OH)2/NF and (Co0.3Mn0.1Ni0.6)(OH)2/NF. FIG. 5b shows that the Mn 2p spectra of Mn(OH)₂/NF are fitted into three peaks corresponding to Mn2+ (642.6 eV), Mn3+ (653.3 eV), and a satellite peak (646.9 eV), respectively.59,61 FIG. 5e shows that the Mn 2p spectrum in (Co0.3Mn0.1Ni0.6)(OH)2/NF could be deconvoluted to three peaks at 653.6, 642.8 eV, and 647.5 eV corresponding to Mn 2p1/2, Mn 2p3/2 and satellite peaks, respectively.59 The peak at 653.6 eV is assigned to Mn3+ and 642.8 eV corresponds to Mn2+. Both Mn3+ and Mn2+ are shifted to higher binding energy in (Co0.3Mn0.1Ni0.6)(OH)2/NF compared to Mn(OH)2/NF. The positive shift in the binding energy of Mn2+ and Mn3+ in (Co0.3Mn0.1Ni0.6)(OH)2/NF compared to Mn(OH)2/NF indicates a decreased electronic density. This result confirmed charge transfer from Mn to Co in (Co0.3Mn0.1Ni0.6)(OH)2/NF. The presence of Mn2+ or Mn3+ mixed oxidation states is also confirmed by a spin-orbit spacing value of 10.8 eV.50,63 FIG. 5c reveals the deconvoluted spectra of Ni 2p in (Co0.3Mn0.1Ni0.6)(OH)2/NF, which show two spin-orbit doublet peaks at 854.7 and 872.2 eV, corresponding to the Ni2+ state. In addition to this, there are two satellite peaks at 860.3 and 877.9 eV in (Co0.3Mn0.1Ni0.6)(OH)2/NF. As illustrated in FIG. 5f, the O 1s spectrum in (Co0.3Mn0.1Ni0.6)(OH)2/NF has been fitted into two peaks at 528.7 and 530.0 eV corresponding to the metal-oxygen and metal-hydroxide bonds, respectively and a third peak at 531.1 eV due to the absorbed water molecules. Based on XPS analysis, Co, Mn, and Ni show Co2+, Mn2+, Mn3+, and Ni2+ oxidation states. The valence electron configuration of Ni2+ and Mn2+ in (Co0.3Mn0.1Ni0.6)(OH)2/NF is t2g6 eg2 and t2g3 eg2, respectively. The Co2+ holds t2g5 eg2 and Mn3+ possesses t2g3 eg1 configuration with one unpaired electron in t2g5 in Co2+ and eg1 in Mn3+. The charge transfer from Mn to Co further influences the adsorption of H₂O. Modulating the electronic structure further influences the adsorption of the reaction intermediates during water splitting. Also, in the multi-metallic system, where Mn is present in multiple oxidation states, it improves the bifunctional catalytic activity. The electrochemical OER performance of the prepared sample was analyzed In N₂-saturated 1M KOH solution at a scan rate of 2 mVs⁻¹. FIG. 6a shows the comparative linear sweep voltammetry (LSVs) plots of the as-prepared materials in comparison to the state-of-the-art RuO₂-coated NF. FIG. 6a reveals that the bare NF shows only negligible OER activity and it requires overpotential of 400 mV to deliver the current density of 10 mAcm⁻². On the other hand, RuO₂@NF needs 330 mV overpotential to reach the same current density of 10 mA cm⁻². In comparison to these, Co(OH)₂/NF and Mn(OH)₂/NF show an overpotential of 320 mV each at 10 mA cm⁻². However, the OER performance is found to be improved substantially in the case of (Co_{0.3}Mn_{0.1}Ni_{0.6})(OH)₂/NF due to the coexistence of Mn with Co, which alters the electron pathway and stabilizes the Co and Ni structures. The XPS investigation has already provided information on the possible electronic modulations incurred by the system. The overpotential exhibited by the (Co_{0.3}Mn_{0.1}Ni_{0.6})(OH)₂/NF at a current density of 10 mA cm⁻² is 270 mV. FIG. 6b represents the bar diagram of the OER overpotentials of the catalysts extracted at 10 mA cm⁻². The Nyquist plots of the materials are given in FIG. 6c. The EIS spectra validate that (Co_{0.3}Mn_{0.1}Ni_{0.6})(OH)₂/NF possesses the charge transfer resistance (R_{CT}) value of 1.0Ω, which is the lowest among the systems investigated and inferring to the faster OER kinetics in the system compared to Co(OH)₂/NF (2.5Ω), Mn(OH)₂/NF (1.2Ω) and NF (3.5Ω) and RuO₂@NF (2.1Ω). To understand the difference in the reaction kinetics, the Tafel slope was calculated using the Tafel equation (η=a+b×logⱼ, where b is the Tafel slope, η is the overpotential, and j is the current density). As represented in FIG. 6d, the reaction kinetics is found to be better on the synthesized (Co_{0.3}Mn_{0.1}Ni_{0.6})(OH)₂/NF (63 MV/decade) as compared to Co(OH)₂/NF (70 MV/decade), Mn(OH)₂/NF (74 MV/decade), Bare NF (101 MV/decade), and RuO₂@NF (99 MV/decade).^{14, 15} The Tafel values indicate that the OER kinetics gets enhanced with the incorporation of the Co and Mn in (Co_{0.3}Mn_{0.1}Ni_{0.6})(OH)₂/NF. FIG. 6e shows the stability analysis of (Co_{0.3}Mn_{0.1}Ni_{0.6})(OH)₂/NF. The chronoamperometric analysis was performed for 24 h at 20 mA cm⁻² and (Co_{0.3}Mn_{0.1}Ni_{0.6})(OH)₂/NF showed a retention of 95% of the initial performance after 24 h of the testing, indicating the excellent stability of the prepared catalyst in the OER conditions. The HER performance of the as-synthesized electrocatalysts was evaluated in N₂-saturated 1M KOH solution at a scan rate of 2 mVs⁻¹. FIG. 7a depicts the comparative LSV profiles of all the materials. The bare NF and Mn(OH)₂/NF show low HER catalytic performance. The Co(OH)₂/NF holds a decent HER activity with an overpotential of 165 mV to deliver the current density of 10 mA cm⁻². On the other hand, (Co_{0.3}Mn_{0.1}Ni_{0.6})(OH)₂/NF exhibits an overpotential of 163 mV to attain the same current density (FIG. 7a). However, in the case of Co(OH)₂/NF, the overpotential increases at higher current densities. Whereas, (Co_{0.3}Mn_{0.1}Ni_{0.6})(OH)₂/NF shows lower ohmic drops as the current density increases. FIG. 7b shows the bar diagram corresponding to the HER overpotential at 10 mA cm⁻². FIG. 7c shows the electrochemical impedance spectra of the as-synthesized materials recorded at −0.30 V vs RHE. It proves that (Co_{0.3}Mn_{0.1}Ni_{0.6})(OH)₂/NF possesses the lowest charge transfer resistance (Rₑₜ) (1.25Ω), indicating the fast HER kinetics from the prepared Co(OH)₂/NF (4.1Ω), Mn(OH)₂/NF (3.3Ω), and NF (2.9Ω) materials. As illustrated in FIG. 7d, (Co_{0.3}Mn_{0.1}Ni_{0.6})(OH)₂/NF shows a Tafel slope of 130 MV/decade and indicates better reaction kinetics compared to the control samples. The Tafel slope values of the control samples are 143, 148, 158, and 96 MV/decade for Co(OH)₂/NF Mn(OH)₂/NF, NF, and PU/C@NF, respectively. FIG. 7e shows the chronoamperometric (CA) stability analysis of (Co_{0.3}Mn_{0.1}Ni_{0.6})(OH)₂/NF. The test was performed for 24 h at 20 mA cm⁻² and the system displayed a performance retention of 85% of the initial value after 24 h.

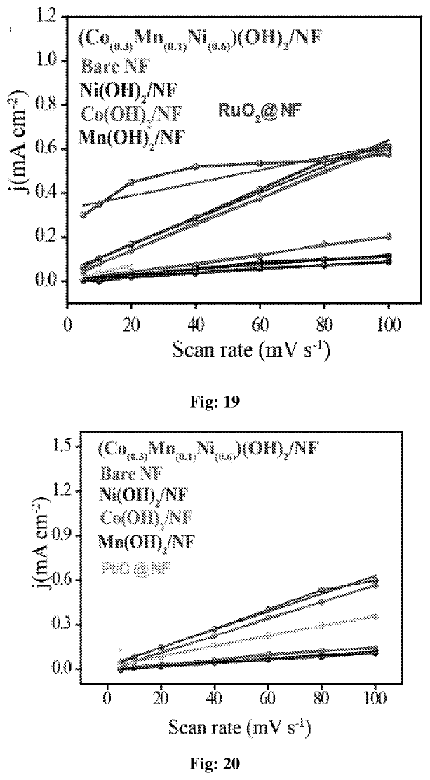

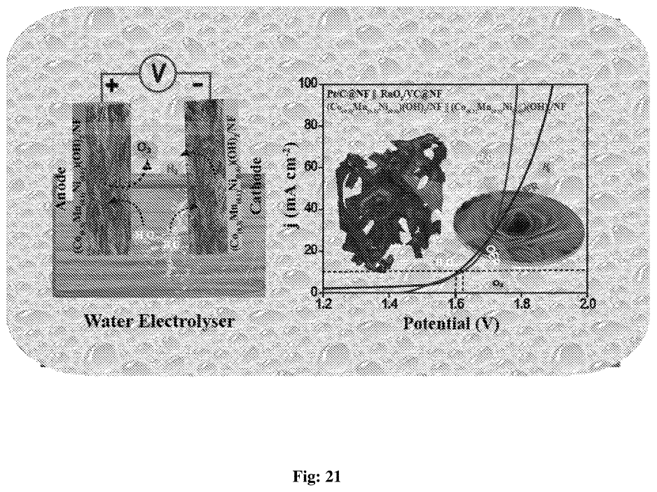

The electrochemical active surface area (ECSA) of the as-prepared samples was calculated from the double-layer capacitance (Cal). For this, CV analysis was conducted with different scan rates in the non-Faradaic region of OER (in 1 M KOH with a potential window of 0.915 to 1.015 V vs. RHE) and HER (in 1 M KOH with a potential window of 0.915 to 0.815 V vs. RHE) as shown in FIGS. 19 and 20. The ECSA is proportional to the C_{dl} value and the catalytic activity is associated with the ECSA. As illustrated in FIG. 19, the C_{dl} values for OER of Bare NE, Ni(OH)₂/NF, Mn (OH)₂/NF, Co(OH)₂/NF, and (Co_{0.3}Mn_{0.1}Ni_{0.6})(OH)₂/NF are 1.9, 1.1, 0.91, 5.8, and 5.92 mF cm⁻¹, respectively. As per FIG. 20, the C_{dl} values for HER of Bare NF, Ni(OH)₂/NF, Mn(OH)₂/NF, Co(OH)₂/NF, and (Co_{0.3}Mn_{0.1}Ni_{0.6})(OH)₂/NF are 1.49, 1.23, 1.14, 5.75, and 6.03 mF cm⁻¹ respectively, which validate the higher ECSA of (Co_{0.3}Mn_{0.1}Ni_{0.6})(OH)₂/NF for OER and HER. This could expose more active sites and thereby improve the catalytic activity. Our claim of the flower-like morphology increases the electrochemically active surface area is proved by the higher C_{dl} value of (Co_{0.3}Mn_{0.1}Ni_{0.6})(OH)₂/NF. For comparison, the state-of-the-art catalysts Pt/C and RuO₂-coated NF (i.e., Pt/C@NF and RuO₂@NF, respectively) were characterized similarly. The obtained C_{dl} values for Pt/C@NF and RuO₂@NF are 3.48 and 2.91 mF cm⁻², respectively.

Finally, overall water splitting was performed in 1M KOH electrolyte and the corresponding data is presented in FIG. 8. The schematic representation of the water electrolyzer is given in FIG. 8a. To investigate the water electrolysis, (Co_{0.3}Mn_{0.1}Ni_{0.6})(OH)₂/NF was employed as both the anode and cathode electrodes in 1M KOH solution by maintaining an active area of 1 cm⁻². For comparison, Bare NF//Bare NF CoMn/NF-(1:1)//CoMn/NF-(1:1) CoMn/NF-(2:1)//CoMn/NF-(2:1) and Pt/C@NF//RuO₂@NF systems were also fabricated and the performance evaluation was done under similar conditions. The bare NF//bare NF shows poor catalytic activity, which requires a potential of 1.81 V to attain the current density of 10 mA cm⁻² (FIG. 8b). Also, CoMn/NF-(1:1)//CoMn/NF-(1:1) and CoMn/NF-(2:1)//CoMn/NF-(2:1) show the poor catalytic activity of 1.75 and 1.81 V, respectively, at 10 mA cm⁻² (FIG. 8c). However, (Co_{0.3}Mn_{0.1}Ni_{0.6})(OH)₂/NF//(Co_{0.3}Mn_{0.1}Ni0.6)(OH)₂/NF system requires 1.62 V to drive a current density of 10 mA cm⁻² which is only 20 mV higher than that of Pt/C@NF//RuO₂@NF. With increasing the current density, (Co_{0.3}Mn_{0.1}Ni_{0.6})(OH)₂/NF//(Co_{0.3}Mn_{0.1}Ni_{0.6})(OH)₂/NF shows better performance (1.78 V @100 mA cm⁻²) compared to Pt/C@NF/RuO₂@NF (1.89 V @100 mA cm⁻²). This could be credited to the improved catalytic activity along with the better mass transport of the electrolyte and evolved gases that occur in (Co_{0.3}Mn_{0.1}Ni_{0.6})(OH)₂/NF due to the nanoflower morphology. Further, FIG. 8d shows the comparative overpotential bar diagram of Pt/C@NF//RuO₂@NF and (Co_{0.3}Mn_{0.1}Ni_{0.6})(OH)₂/NF//(Co_{0.3}Mn_{0.1}Ni_{0.6})(OH)₂/NF systems recorded at different current densities. At the current densities of 10, 50, and 100 mA cm⁻², the respectively measured potentials for the (Co_{0.3}Mn_{0.1}Ni_{0.6})(OH)₂/NF/(Co_{0.3}Mn_{0.1}Ni_{0.6})(OH)₂/NF system are 1.62, 1.75 and 1.78 V, whereas, for Pt/C@NF//RuO₂@NF system, these values are respectively 1.60, 1.79, and 1.89 V. Afterward, the stability analysis of the (Co_{0.3}Mn_{0.1}Ni_{0.6})(OH)₂/NF//(Co_{0.3}Mn_{0.1} Ni_{0.6})(OH)₂/NF system was performed at 20 mA cm⁻² for 24 h. The chronoamperometric analysis illustrated in FIG. 8e shows a stable performance for 24 h. The inset of FIG. 8e shows gas evolution during water splitting using the paired configuration of the (Co_{0.3}Mn_{0.1}Ni_{0.6})(OH)₂/NF bifunctional electrocatalyst. During the overall water-splitting process, the evolved gases were quantified by using gas chromatography. For this, a homemade two-compartment set-up was fabricated. (Co_{0.3}Mn_{0.1}Ni_{0.6})(OH)₂/NF was used as the cathode and anode electrodes. The anion exchange membrane (Fumatech FAA-3) was used as the separator between the anode and cathode chamber. The chronoamperometric analysis was performed at 1.90 V for 2 h. The produced gas was collected in the headspace of the respective chambers and was injected into the GC instrument by using a micro syringe (500 μL). The amounts of H₂ and O₂ produced are estimated to be 701.2 and 358.6 mmol, respectively, at the time interval of 1 h; these amounts are corresponding to the ~1:2 ratio of O₂ and H₂, respectively. This study confirms the capability for employing (Co_{0.3}Mn_{0.1}Ni_{0.6})(OH)₂/NF as the bi-functional and self-standing electrodes for the realistic demonstrations of the overall water splitting applications.

In summary, the flower-like morphology of (Co_{0.3}Mn_{0.1}Ni_{0.6})(OH)₂ was synthesized on nickel foam (NF) using a simple hydrothermal method. The self-supported (Co_{0.3}Mn_{0.1}Ni_{0.6})(OH)₂/NF having the porous flower-like morphology significantly reduces the mass-transport related issues during the overall water splitting process. The electronic and morphological modification is well understood after Mn incorporation. The (Co_{0.3}Mn_{0.1}Ni_{0.6})(OH)₂/NF system possesses remarkably high activity toward both OER and HER in a 1 M KOH solution. The overpotentials displayed by this system at 10 mA cm⁻² are 270 mV for OER, and 163 mV for HER. The structural stability analysis of (Co_{0.3}Mn_{0.1}Ni_{0.6})(OH)₂/NF during OER and HER shows outstanding durability and structural integrity of the system. The (Co_{0.3}Mn_{0.1}Ni_{0.6})(OH)₂/NF bifunctional electrocatalyst was finally employed both as the cathode and anode electrodes for the overall water splitting in 1M KOH. The system required only 1.62 V to achieve the current density of 10 mA cm⁻² with excellent long-term stability. The value is comparable to many of the recently reported works. Further, supplementary data was generated to substantiate the invention. For comparison, two more samples were synthesized under similar conditions with the different molar ratios of the cobalt and manganese (Mn:Co of 0.5:0.5 and 0.5:1 mmol) and the samples are designated correspondingly as CoMn/NF-(1:1) and CoMn/NF-(2:1).

TABLE 1
Comparison of the OER, HER and the
overall water-splitting activities of the
(Co_{0.3}Mn_{0.1}Ni_{0.6})(OH)₂/NF, CoMn/NF-(1:1)
and CoMn/NF-(2:1).

| | | | OER | HER | OWS |
|---|---|---|---|---|---|
| | | | Potential | Potential | Potential |
| | | | (mV) @ | (mV) @ | (V) @ |
| Sr. | | | 10 mA | 10 mA | 10 mA |
| No. | Electrocatalyst | Electrolyte | cm⁻² | cm⁻² | cm⁻² |
| 1. | CoMn/NF-(1:1) | 1M KOH | 310 | 242 | 1.75 |
| 2. | CoMn/NF-(2:1) | 1M KOH | 320 | 286 | 1.81 |
| 3. | (Co_{0.3}Mn_{0.1}Ni_{0.6}) | 1M KOH | 270 | 163 | 1.62 |
| | (OH)₂/NF | | | | |

### Advantages of the Invention

Bifunctional electrochemical catalyst provides better electrode/electrolyte interface. Bifunctional electrochemical catalyst having hydrophilic nature minimizes the mass-transport-related issues. The catalyst is highly stable and cost effective. Benefitting better interaction with electrolytes and reactants during electrochemical process. Catalyst act as binder free bifunctional electrode. Employing the catalyst as a cathode and anode. Bifunctional electrochemical catalyst prepared by one-step hydrothermal synthesis. Material and solvent used are less toxic.

1-10. (canceled)

11. A bifunctional electrocatalyst comprising ternary metals hydroxide composite having formula of (M1-M2-Ni)(OH)₂ supported onto a support; wherein, the hydroxides of M1, M2 and nickel are uniformly present over the support; and wherein the bifunctional electrocatalyst composite has a hierarchical nanoflower morphology, wherein the bifunctional electrocatalyst is self-standing and crystalline in nature.

12. The bifunctional electrocatalyst as claimed in claim 11, wherein M1 metal is selected from Mn, Zn, Fe, Cu and Ni, and M2 metal is selected from Co, Zn, Fe, Cu and Ni.

13. The bifunctional electrocatalyst as claimed in claim 11, wherein the support is selected from nickel foam, copper foam, titanium foil and carbon cloth.

14. The bifunctional electrocatalyst as claimed in claim 11, wherein the M1 metal is Mn, the M2 metal is Co, and the support is nickel foam.

15. The bifunctional electrocatalyst as claimed in claim 12, wherein the amount of Mn-hydroxide is in the range of 10-20% of total weight of the electrocatalyst, the amount of Co-hydroxide is in the range of 20-30% of total weight of the electrocatalyst, and nickel hydroxide is in the range of 50-60% of total weight of the electrocatalyst.

16. The bifunctional electrocatalyst as claimed in claim 12, wherein the oxidation states of metals Mn, Co and Ni in the composite catalyst are: Ni as +2, Co as +2, and Mn as +2 and +3.

17. A one-pot hydrothermal process for preparation of bifunctional electrocatalyst as claimed in claim 1, comprising the steps of:
i. cleaning the support with HCl, deionized water, and ethanol consecutively by bath sonication for 10-15 min followed by drying in the vacuum oven at 50-60° C. for 5-6 h to obtain a precleaned support;
ii. dispersing precursors of M1 metal salt and M2 metal salt in deionized water by stirring for 10-25 min at 20-25° C. to obtain a solution;
iii. transferring the solution of step (ii) and the precleaned support of step (i) into a Teflon-lined autoclave placed in oven;
iv. performing hydrothermal treatment of step (iii) at 170-180° C. for 11-13 h in the oven containing the autoclave followed by cooling down to 25° C. to obtain a mixture;
V. removing the Teflon-lined autoclave from the oven and then removing the material as obtained in step (iv) from the Teflon-lined autoclave, followed by washing the material three times with an ethanol-DI water mixture (1:1); and
vi. drying the obtained material from step (v) in a vacuum oven for 5-6 h at 60-70° C. to obtain the bifunctional electrocatalyst.

18. The process as claimed in claim 17, wherein the precursor of M1 metal is selected from manganese acetate, iron acetate, zinc acetate, copper sulfate, copper acetate, and nickel acetate; wherein the precursor of M2 metal is selected from cobalt nitrate, iron nitrate, zinc nitrate, copper nitrate, and nickel nitrate; and the support is selected from nickel foam, copper foam, titanium foil and carbon cloth.

19. A half-cell comprising a working electrode, a reference electrode, and a counter electrode within an electrolyte solution, wherein the working electrode comprises the bifunctional electrocatalyst as claimed in claim 11.

20. The half-cell as claimed in claim 19, wherein the reference electrode is made of mercury (Hg) and mercury (II) oxide (HgO), and the counter electrode is made of graphite rod; and wherein the electrolyte solution is selected from a basic solution of potassium hydroxide in the range of 1-4 M, and an acidic solution comprising hydrochloric acid, sulfuric acid or a combination thereof with concentration in the range of 1-4 M.

21. A full-cell comprising a cathode, an anode, and an electrolyte solution; wherein the cathode and/or the anode comprise the bifunctional electrocatalyst as claimed in claim 11.

22. The full-cell as claimed in claim 21, wherein the electrolyte solution is potassium hydroxide or sodium hydroxide with concentration in the range of 1-4 M; and wherein the electrocatalyst demonstrates catalytic activity for both an oxygen evolution reaction (OER) and a hydrogen evolution reaction (HER) in the full-cell.
